(19) United States
(12) Patent Application Publication
(10) Pub. No.: US 2017/0132850 A1
(43) Pub. Date: May 11, 2017

(54) DATA PROCESSING METHOD, DEVICE AND SYSTEM

(71) Applicant: Leauto Intelligent Technology (BEIJING) Co. Ltd., Beijing (CN)

(72) Inventors: Peng Liu, Beijing (CN); Kunsheng Chen, Beijing (CN); Wei Lin, Beijing (CN); Dan Li, Beijing (CN); Yong Xu, Beijing (CN); Yu Zou, Beijing (CN); Wenrui Li, Beijing (CN); Xiaofei Gou, Beijing (CN)

(73) Assignee: Leauto Intelligent Technology (BEIJING) Co. Ltd., Beijing (CN)

(21) Appl. No.: 14/979,875

(22) Filed: Dec. 28, 2015

(30) Foreign Application Priority Data
Nov. 11, 2015 (CN) 201510768316X

(51) Int. Cl. G07C 5/00; G07C 5/08; G06Q 50/26; G07C 5/02

(52) U.S. Cl. CPC G07C 5/008; G07C 5/02; G07C 5/0841; G06Q 50/265

(57) ABSTRACT

Embodiments of the present disclosure provide a data processing method, device and system. The method comprises: acquiring the acquired data of a traveling data recorder, wherein the acquired data at least comprises video data and/or driving behavior data, and the driving behavior data at least comprises running distance, running speed, running acceleration, running angular speed and/or running position; and transmitting the acquired data to electronic equipment connected with the traveling data recorder, triggering the electronic equipment to transmit the acquired data to an application server, and sending, by the application server, the acquired data or data satisfying a sharing condition in the acquired data to any electronic equipment associated with the electronic equipment. The embodiments of the present disclosure improve the utilization rate of the traveling data recorder and enrich the function of the traveling data recorder.

### CROSS-REFERENCE TO RELATED APPLICATIONS

Pursuant to 35 U.S.C. §119 and the Paris Convention Treaty, this application claims the benefit of Chinese Patent Application No. 201510768316X filed on Nov. 11, 2015, entitled “Data Processing Method, Device and System”, the contents of which are incorporated herein by reference.

### FIELD OF TECHNOLOGY

Embodiments of the present disclosure relate to the technical field of automobiles, and particularly relate to a data processing method, device and system.

### BACKGROUND

A traveling data recorder is an apparatus for recording such information as images, sound and the like during running of a vehicle. After the traveling data recorder is installed in a vehicle, it can record images, sound and the like in the entire running process of the vehicle, can provide evidence for traffic accidents, and can also be used as an independent camera for shooting images and the like in a driving process.

With the popularization of the traveling data recorder, it has become an indispensable accessory in a vehicle. However, for acquisition of images and sound, the present traveling data recorder is merely limited to recording them, and the images and the sound have to be viewed by reading a storage medium in the traveling data recorder, so the traveling data recorder is relatively single in function and increasingly cannot meet the needs of users, and its function should be improved urgently.

### SUMMARY

One objective of the present disclosure is to provide a data processing method, device and system, which may solve the technical problem of single function of a traveling data recorder in the prior art and enriching the function of the traveling data recorder.

In a first aspect of the embodiments of the present disclosure, provided is a data processing method, applied to a traveling data recorder, the method including:

acquiring the acquired data of the traveling data recorder, wherein the acquired data at least includes video data and/or driving behavior data, and the driving behavior data at least includes running distance, running speed, running acceleration, running angular speed and/or running position; and
transmitting the acquired data to electronic equipment connected with the traveling data recorder, triggering the electronic equipment to transmit the acquired data to an application server, and sending, by the application server, the acquired data or data satisfying a sharing condition in the acquired data to any electronic equipment associated with the electronic equipment.

In a second aspect of the embodiments of the present disclosure, provided is a data processing method, applied to electronic equipment, the method including:

receiving acquired data transmitted by a traveling data recorder, wherein the acquired data is acquired and obtained by the traveling data recorder and at least includes video data and/or driving behavior data, and the driving behavior data at least includes running distance, running speed, running acceleration, running angular speed and/or running position; and
transmitting the acquired data to an application server, and sending, by the application server, the acquired data or data satisfying a sharing condition in the acquired data to any electronic equipment associated with the electronic equipment.

In a third aspect of the embodiments of the present disclosure, provided is a data processing method, applied to an application server, the method including:

receiving acquired data transmitted by electronic equipment, wherein the acquired data is acquired by and transmitted to the electronic equipment by the traveling data recorder and at least includes video data and/or driving behavior data, and the driving behavior data at least includes running distance, running time, running speed, running acceleration, running angular speed and/or running position; and
transmitting the acquired data or data satisfying a sharing condition in the acquired data to any electronic equipment associated with the electronic equipment.

In a fourth aspect of the embodiments of the present disclosure, provided is a data processing device, applied to a traveling data recorder, the device including: a first acquisition unit for acquiring the acquired data of the traveling data recorder, wherein the acquired data at least includes video data and/or driving behavior data, and the driving behavior data at least includes running distance, running speed, running acceleration, running angular speed and/or running position; and

a first transmission unit for transmitting the acquired data to electronic equipment connected with the traveling data recorder, triggering the electronic equipment to transmit the acquired data to an application server, and sending, by the application server, the acquired data or data satisfying a sharing condition in the acquired data to any electronic equipment associated with the electronic equipment.

In a fifth aspect of the embodiments of the present disclosure, provided is a data processing device, applied to electronic equipment, the device including:

a second acquisition unit for receiving acquired data transmitted by a traveling data recorder, wherein the acquired data is acquired and obtained by the traveling data recorder and at least includes video data and/or driving behavior data, and the driving behavior data at least includes running distance, running speed, running acceleration, running angular speed and/or running position; and
a second transmission unit for transmitting the acquired data to an application server, and sending, by the application server, the acquired data or data satisfying a sharing condition in the acquired data to any electronic equipment associated with the electronic equipment.

In a sixth aspect of the embodiments of the present disclosure, provided is a data processing device, applied to an application server, the device including:

a third acquisition unit for receiving acquired data transmitted by electronic equipment, wherein the acquired data is acquired by and transmitted to the electronic equipment by the traveling data recorder and at least includes video data and/or driving behavior data, and the driving behavior data at least includes running distance, running time, running speed, running acceleration, running angular speed and/or running position; and a third transmission unit for transmitting the acquired data or data satisfying a sharing condition in the acquired data to any electronic equipment associated with the electronic equipment.

In a seventh aspect of the embodiments of the present disclosure, provided is a data processing system, including a traveling data recorder, electronic equipment and an application server;

the traveling data recorder is used for acquiring data and transmitting the acquired data to the electronic equipment, and includes the data processing device provided by the fourth aspect of the embodiments of the present disclosure;
the electronic equipment is used for receiving the acquired data transmitted by the traveling data recorder and transmitting the acquired data to the application server, and includes the data processing device provided by the fifth aspect of the embodiments of the present disclosure; and
the application server is used for transmitting the acquired data or data satisfying a sharing condition in the acquired data to any electronic equipment associated with the electronic equipment, and includes the data processing device provided by the sixth aspect of the embodiments of the present disclosure.

In an eight aspect of the embodiments of the present disclosure, a data processing device, applied to a traveling data recorder, comprising:
one or more processors; and
a storage;
one or more programs, stored in the storage and performing the following steps when being executed by the one or more processors:
acquiring the acquired data of the traveling data recorder, wherein the acquired data at least comprises video data and/or driving behavior data, and the driving behavior data at least comprises running distance, running speed, running acceleration, running angular speed and/or running position; and
transmitting the acquired data to electronic equipment connected with the traveling data recorder, triggering the electronic equipment to transmit the acquired data to an application server, and sending, by the application server, the acquired data or data satisfying a sharing condition in the acquired data to any electronic equipment associated with the electronic equipment.

In a class of embodiments, the acquired data comprises a current vehicle running image, and the step of acquiring the acquired data of the traveling data recorder comprises acquiring and obtaining a current vehicle running image when receiving an image acquisition instruction.

In a class of embodiment, the step of acquiring a current vehicle running image when receiving an image acquisition instruction comprises:

acquiring and obtaining a current vehicle running image when receiving an image acquisition instruction generated when control equipment arranged in a steering wheel responds to a user trigger operation.

In a ninth aspect of embodiments of the present disclosure, a data processing device, applied to electronic equipment, comprises:
one or more processors; and
a storage;
one or more programs, stored in the storage and performing the following steps when being executed by the one or more processors:
receiving acquired data transmitted by a traveling data recorder, wherein the acquired data is acquired and obtained by the traveling data recorder and at least comprises video data and/or driving behavior data, and the driving behavior data at least comprises running distance, running speed, running acceleration, running angular speed and/or running position; and
transmitting the acquired data to an application server, and sending, by the application server, the acquired data or data satisfying a sharing condition in the acquired data to any electronic equipment associated with the electronic equipment.

In a class of embodiments, the device of claim 14, further comprises one or more programs, stored in the storage and performing the step of
receiving and outputting a driving behavior analysis result fed back by the application server, wherein the driving behavior analysis result is obtained by counting the driving behavior data cumulatively received within a preset time through the application server, and is used for expressing whether the driving behavior habit of the vehicle is safe.

In tenth aspect of embodiment of the present disclosure, a data processing device, applied to an application server, comprises
one or more processors; and
a storage;
one or more programs, stored in the storage and performing the following steps when being executed by the one or more processors:
receiving acquired data transmitted by electronic equipment, wherein the acquired data is acquired by and transmitted to the electronic equipment by the traveling data recorder and at least comprises video data and/or driving behavior data, and the driving behavior data at least comprises running distance, running time, running speed, running acceleration, running angular speed and/or running position; and
transmitting the acquired data or data satisfying a sharing condition in the acquired data to any electronic equipment associated with the electronic equipment.

In a class of embodiments, the device further comprises one or more programs, stored in the storage and performing the steps of
counting the driving behavior data cumulatively received within a preset time to obtain a driving behavior analysis result, wherein the driving behavior analysis result is used for expressing whether the driving behavior habit of the vehicle is safe; and
sending the driving behavior analysis result to the electronic equipment for output by the electronic equipment.

In a class of embodiments, the device comprises one or more programs, stored in the storage and performing the steps of
counting the driving behavior data cumulatively received within the preset time, to at least obtain an overspeed frequency that the running speed is greater than a speed threshold, a sharp acceleration frequency that the running acceleration is greater than an acceleration threshold, a sharp turning frequency that the running angular speed is greater than an angular speed threshold, and a running frequency at a preset running position; and
obtaining a driving behavior habit safety level as the driving behavior analysis result according to the overspeed frequency, the acceleration frequency, the sharp turning frequency, the running frequency at the preset running position, the running distance and the running time within the preset time.

In a class of embodiments, the device further comprises one or more programs, stored in the storage and performing the step of
comparing the driving behavior habit safety level with the driving behavior habit safety level obtained from the driving behavior data transmitted by any electronic equipment associated with the electronic equipment, to obtain a comparison result as the driving behavior analysis result.

In a class of embodiments, the device further comprises one or more programs, stored in the storage and performing the step of:
sending road condition information corresponding to the running position in the driving behavior data to the electronic equipment for output by the electronic equipment.

In the data processing method, device and system provided by the embodiments of the present disclosure, the acquired data of the traveling data recorder can be transmitted to the electronic equipment and then transmitted to the application server by the electronic equipment, and the application server can transmit the acquired data or the data satisfying the sharing condition in the acquired data to any electronic equipment associated with the electronic equipment, so that data sharing is realized, the driving interactivity is improved and the driving fun is improved. According to the embodiments of the present disclosure, the traveling data recorder is sufficiently utilized for not only acquiring video data, but also sharing data through the electronic equipment and the application server, so that the function of the traveling data recorder is enriched and the user experience is improved.

### BRIEF DESCRIPTION OF THE DRAWINGS

In order to describe the technical solutions in the embodiments of the present disclosure or in the prior art more clearly, a simple introduction to the accompanying drawings which are needed in the description of the embodiments or the prior art is given below. Apparently, the accompanying drawings in the description below are merely some of the embodiments of the present disclosure, based on which other drawings may be obtained by those of ordinary skill in the art without any creative effort.

FIG. 1 is a flow diagram of an embodiment of a data processing method of the present disclosure;

FIG. 2 is a flow diagram of another embodiment of the data processing method of the present disclosure;

FIG. 3 is a flow diagram of a further embodiment of the data processing method of the present disclosure;

FIG. 4 is a flow diagram of a further embodiment of the data processing method of the present disclosure;

FIG. 5 is a flow diagram of a further embodiment of the data processing method of the present disclosure;

FIG. 6 is a structural schematic diagram of an embodiment of a data processing device of the present disclosure;

FIG. 7 is a structural schematic diagram of another embodiment of the data processing device of the present disclosure;

FIG. 8 is a structural schematic diagram of a further embodiment of the data processing device of the present disclosure;

FIG. 9 is a structural schematic diagram of a further embodiment of the data processing device of the present disclosure;

FIG. 10 is a structural schematic diagram of a further embodiment of the data processing device of the present disclosure;

FIG. 11 is a structural schematic diagram of an embodiment of a data processing system of the present disclosure.

### DESCRIPTION OF THE EMBODIMENTS

To make the objectives, technical solutions and advantages of the embodiments of the present disclosure clearer, a clear and complete description of the technical solutions in the present disclosure will be given below, in conjunction with the accompanying drawings in the embodiments of the present disclosure. Apparently, the embodiments described below are a part, but not all, of the embodiments of the present disclosure. All of other embodiments, obtained by those of ordinary skill in the art based on the embodiments of the present disclosure without any creative effort, fall into the protection scope of the present disclosure.

As described in the background section, with the popularization of the traveling data recorder, it has become an indispensable accessory in a vehicle, but the function of the traveling data recorder is single, and how to effectively utilize the traveling data recorder to increase its function and bring better driving experience to a user becomes a main development prospect thereof.

Thus, the inventor proposes the technical solutions of the present disclosure through a series of studies. In the embodiments of the present disclosure, the traveling data recorder can be connected with electronic equipment, the electronic equipment can be connected with an application server, the acquired data of the traveling data recorder can be transmitted to the electronic equipment and transmitted to the application server by the electronic equipment, and the application server can send the acquired data or data satisfying a sharing condition in the acquired data to any electronic equipment associated with the electronic equipment, so that data sharing is realized, the driving interactivity can be increased and the driving fun is improved. The traveling data recorder is sufficiently utilized in the embodiments of the present disclosure, so that the traveling data recorder not only can be used for acquiring video data and recording the influence in the running process of a vehicle, but also can be connected with the electronic equipment to transmit and share the acquired data, thus, the function of the traveling data recorder is enriched.

The technical solutions of the present disclosure will be described in detail below in conjunction with the accompanying drawings.

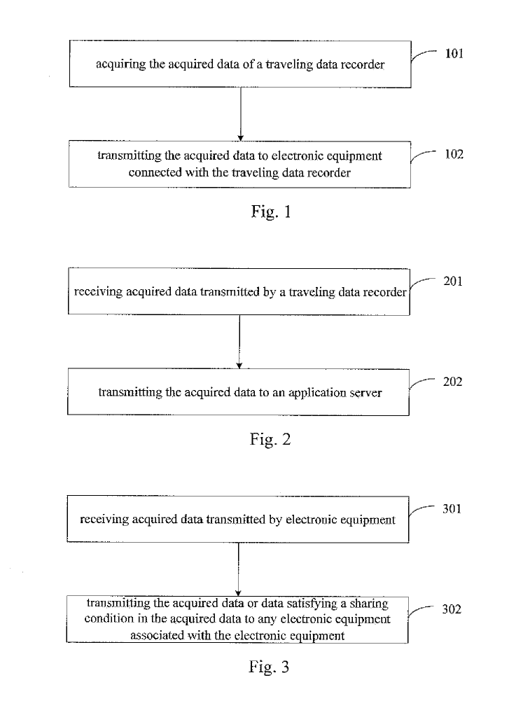

FIG. 1 is a flow diagram of an embodiment of a data processing method of the present disclosure. The method is specifically applied to a traveling data recorder, and may include the following several steps.

101: acquired data of the traveling data recorder is acquired.

The acquired data may include video data and/or driving behavior data.

The driving behavior data may include driving distance, driving locus, driving speed, driving acceleration, driving angular speed and/or driving position; the driving behavior data may further include a lane line distance and a front vehicle distance.

The lane departure data and the front vehicle distance can be acquired by recognizing video images in the video data.

By recognizing the video images, the lane line of a vehicle running lane, the distance between the vehicle and the lane line, the front vehicle distance and the like can be acquired.

Of course, the driving behavior data may further include other data and the like involved in the vehicle driving process.

The traveling data recorder in the embodiments of the present disclosure may at least include an image acquisition module, a motion parameter detection module, a positioning module and the like.

The image acquisition module may be a camera and the like, for example, and is used for acquiring images and video and the like in the vehicle running process. The traveling data recorder is generally installed on a front windshield or around a rear reflector of a vehicle, to obtain a relatively wide view acquisition range of the traveling data recorder, so as to acquire running video data.

The motion parameter detection module may include sensors capable of detecting motion parameters, such as a speed sensor, an acceleration sensor, an angular speed sensor or a gyro, etc., so as to acquire data of running speed, running acceleration, running angular speed, running direction and the like of a vehicle.

The positioning module may be a device for positioning, such as a GPS (Global Positioning System), so as to acquire data of running locus, running distance, running position and the like.

The acquired data can be acquired in real time during running of the vehicle.

102: the acquired data is transmitted to electronic equipment connected with the traveling data recorder, the electronic equipment is triggered to transmit the acquired data to an application server, and the application server sends the acquired data or data satisfying a sharing condition in the acquired data to any electronic equipment associated with the electronic equipment.

The connection between the electronic equipment and the traveling data recorder may be in multiple manners, and may be short-distance wireless connection, such as Bluetooth connection and the like. In order to improve the data transmission efficiency, the electronic equipment may be connected with the traveling data recorder through wifi (Wireless-Fidelity), the traveling data recorder is used as a wifi hotspot, the electronic equipment can be connected to the traveling data recorder by searching, and such data occupying much bandwidth as video data can be quickly transmitted through wifi connection.

The acquired data of the traveling data recorder can be transmitted to the electronic equipment by connecting it with the electronic equipment.

The electronic equipment can automatically transmit the acquired data to the application server after receiving the acquired data. The electronic equipment can request the traveling data recorder for acquiring the acquired data in real time, or the traveling data recorder actively transmits the acquired data to the electronic equipment.

Different electronic equipment receives the acquired data of the respective connected traveling data recorder and can transmit the acquired data to the application server.

The application server receives the acquired data transmitted by the electronic equipment, and can transmit the acquired data or the data satisfying the sharing condition in the acquired data to any electronic equipment associated with the electronic equipment, so that a user can share data with other users in real time during driving, the driving interactivity can be increased and the driving fun can be improved.

The sharing condition may indicate a preset type of data, such as running locus, running speed, running position, video images and the like.

The sharing condition may further indicate data requested for sharing by a user, that is, the electronic equipment can receive a user request, and the data requested for sharing by a user in the driving behavior data can be shared according to the user request.

Of course, the data satisfying the sharing condition in the acquired data can be transmitted from the electronic equipment to the application server, that is, the electronic equipment judges the acquired data and transmits the data satisfying the sharing condition to the application server.

The application server can share the acquired data or the data satisfying the sharing condition in the acquired data to any electronic equipment associated with the electronic equipment, so as to increase the driving interactivity and improve the driving fun.

The electronic equipment specifically logs into the application server through an application account, to establish a connection with the application server, and any electronic equipment associated with the electronic equipment is the one corresponding to a friend account of the application account.

In the embodiment of the present disclosure, the traveling data recorder can be connected with the electronic equipment and transmit the acquired data thereof to the electronic equipment, the electronic equipment can transmit the acquired data to the application server, and the application server can send the acquired data or the data satisfying the sharing condition in the acquired data to any electronic equipment associated with the electronic equipment, so that the driving interactivity is increased and the driving fun is improved. According to the technical solution of the embodiment of the present disclosure, the traveling data recorder not only can be used for recording images during running of a vehicle, but also can interact data with the electronic equipment, thus realizing data sharing with other electronic equipment, improving the driving fun, enriching the function of the traveling data recorder and improving the user experience.

In the embodiment of the present disclosure, the electronic equipment may be portable mobile equipment such as a mobile phone, a tablet personal computer and the like. The portable mobile equipment is generally carried by a user, and when the user drives a vehicle, the carried electronic equipment can be connected with the traveling data recorder in the vehicle, so that data sharing can be realized to improve the driving safety and the driving fun.

As another embodiment, the acquired data of the traveling data recorder may further include a current vehicle running image. Thus, acquiring the acquired data of the traveling data recorder may include:

acquiring and obtaining a current vehicle running image when receiving an image acquisition instruction.

Hence, the electronic equipment may further transmit the current vehicle running image to the application server, and the application server sends the current vehicle running image to any electronic equipment associated with the electronic equipment.

During running of the vehicle, the image recorded by the traveling data recorder is video data. If a user desires to record key environment content of a scene along the way or at an important position during running of the vehicle, a video recording manner is adopted, and it is relatively cumbersome to search the key environment content from the video data later.

Thus, in the embodiment of the present disclosure, the image acquisition module in the traveling data recorder can also be utilized for shooting to acquire the current vehicle running image.

The image acquisition instruction may be sent from the electronic equipment to the traveling data recorder or from control equipment to the traveling data recorder.

The electronic equipment or the control equipment may send the image acquisition instruction to the traveling data recorder when receiving a trigger operation of a user.

In order to facilitate user operation, the control equipment may be arranged in a steering wheel of the vehicle, so that when the user discovers a beautiful scene or other environment content desired to be shot, the user can operate the control equipment on the steering wheel in time, and the control equipment can generate an image acquisition instruction and send the image acquisition instruction to the traveling data recorder, to trigger the traveling data recorder to perform image acquisition and shoot a current running image.

Thus, acquiring a current vehicle running image when receiving the image acquisition instruction may be:

acquiring a current vehicle image when receiving an image acquisition instruction generated when the control equipment arranged in the steering wheel responds to a user trigger operation.

After receiving the current running image, the application server can automatically send the current running image to any electronic equipment associated with the electronic equipment, so that the current running image is shared to any associated electronic equipment in time and timely sharing between the user and a friend is realized.

FIG. 2 is a flow diagram of another embodiment of the data processing method of the present disclosure. The method is specifically applied to electronic equipment, and the electronic equipment may be any electronic equipment connected with a traveling data recorder in a vehicle.

The method may include the following several steps.

201: acquired data transmitted by a traveling data recorder is received.

The acquired data is acquired and obtained by the traveling data recorder during running of the vehicle and at least includes video data and/or driving behavior data, and the driving behavior data at least includes running distance, running speed, running acceleration, running angular speed and/or running position.

The electronic equipment can request the traveling data recorder for transmitting the driving behavior data in real time, or the traveling data recorder actively sends the acquired driving behavior data to the electronic equipment.

202: the driving behavior data is transmitted to an application server, and the application server sends the acquired data or data satisfying a sharing condition in the acquired data to any electronic equipment associated with the electronic equipment.

The electronic equipment may further receive acquired data of the traveling data recorder connected with any electronic equipment associated with the electronic equipment or data satisfying a sharing condition, which is sent by the application server.

In this embodiment, the electronic equipment can be connected with the traveling data recorder in the vehicle so as to receive or request for acquiring the acquired data of the traveling data recorder and can transmit the acquired data to the application server, and the application server sends the acquired data to any electronic equipment associated with the electronic equipment. Any electronic equipment associated with the electronic equipment may be the one corresponding to a friend of the electronic equipment user. Thus, during running of the vehicle, data sharing with a friend is realized, the driving interactivity is increased, the driving fun is improved, the traveling data recorder is sufficiently utilized, and the function of the traveling data recorder is enriched.

As another embodiment, the application server can further count the driving behavior data in the acquired data to obtain a driving behavior analysis result after receiving the acquired data, wherein the driving behavior analysis result is used for expressing whether the driving behavior habit of the vehicle is safe.

The application server can further feed back the obtained driving behavior analysis result to the electronic equipment for output by the electronic equipment, to prompt the user whether the current driving behavior habit is safe, so that the user can correct the driving behavior habit to keep a safe driving behavior.

Thus, after the electronic equipment transmits the driving behavior data to the application server, the method may further include:

receiving and outputting a driving behavior analysis result fed back by the application server, wherein the driving behavior analysis result is obtained by counting the driving behavior data cumulatively received within a preset time through the application server, and is used for expressing whether the driving behavior habit of the vehicle is safe.

The driving behavior analysis result is obtained by processing the driving behavior data cumulatively received within the preset time, namely a large amount of driving behavior data, thus ensuring the accuracy of the analysis result. The preset time may be ten days, one month, six months or one year, etc.

The driving behavior data may be processed to obtain a driving behavior assessment result in multiple manners, which will be introduced in detail in the following embodiments.

The acquired data of the traveling data recorder, received by the electronic equipment, includes a current vehicle running image acquired and obtained when the traveling data recorder receives an image acquisition instruction.

That is, the image acquisition module shoots an image when receiving the image acquisition instruction.

The image acquisition instruction received by the traveling data recorder may specifically be generated when the control equipment connected with the traveling data recorder responds to a user trigger operation.

The connection between the control equipment and the traveling data recorder may be a short-distance wireless communication connection, e.g. Bluetooth connection and the like. In order to facilitate user operation, the control equipment may be arranged in a steering wheel.

Of course, the image acquisition instruction of the traveling data recorder may also be generated by triggering a user to operate the electronic equipment, that is, the user can operate the electronic equipment, thus achieving the purpose of shooting an image with the traveling data recorder during running of the vehicle.

FIG. 3 is a flow diagram of a further embodiment of the data processing method of the present disclosure. The method is specifically applied to an application server.

The application server may be connected with different electronic equipment, and the different electronic equipment logs into the application server through respective application account to communicate with the application server.

The method may include the following steps:

301: receiving acquired data transmitted by electronic equipment, wherein the acquired data is acquired by and transmitted to the electronic equipment by the traveling data recorder and at least includes video data and/or driving behavior data, and the driving behavior data at least includes running distance, running time, running speed, running acceleration, running angular speed and/or running position; and
302: transmitting the acquired data or data satisfying a sharing condition in the acquired data to any electronic equipment associated with the electronic equipment.

The sharing condition may be a preset type of data, or data requested for sharing by a user.

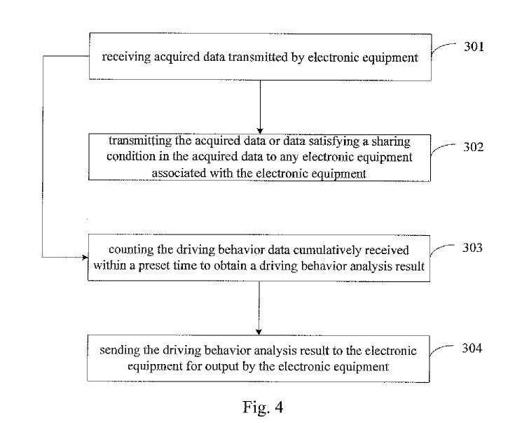

As a further embodiment, as shown in FIG. 4, after receiving the acquired data transmitted by the electronic equipment in step 301, the method further includes:

303: counting the driving behavior data cumulatively received within a preset time to obtain a driving behavior analysis result.

The driving behavior analysis result is used for expressing whether the driving behavior habit of the vehicle is safe; and

304: sending the driving behavior analysis result to the electronic equipment for output by the electronic equipment.

In the embodiment of the present disclosure, the traveling data recorder can be connected with the electronic equipment and transmit the acquired driving behavior data to the electronic equipment, the electronic equipment can transmit the driving behavior data to the application server, and the application server not only transmits the acquired data or the data satisfying the sharing condition in the acquired data to any electronic equipment associated with the electronic equipment to increase the driving interactivity and improve the driving fun, but also can count a large amount of cumulatively received driving behavior data to obtain a driving behavior analysis result for expressing whether the driving behavior habit is safe, and sends the driving behavior analysis result to the electronic equipment, and the electronic equipment outputs the driving behavior analysis result, so that a user can learn own driving behavior habit in time to improve the driving safety. In the embodiment of the present disclosure, the traveling data recorder is sufficiently utilized for recording images and video during running of the vehicle, so that the function of the traveling data recorder is enriched.

The driving behavior analysis result may include driving behavior habit, driving behavior habit safety level, result of comparison with other user driving behavior habit, etc.

Thus, as a further embodiment, counting the driving behavior data cumulatively received within a preset time to obtain a driving behavior analysis result may include: counting the driving behavior data cumulatively received within the preset time, to at least obtain an overspeed frequency that the running speed is greater than a speed threshold, a sharp acceleration frequency that the running acceleration is greater than an acceleration threshold, a sharp turning frequency that the running angular speed is greater than an angular speed threshold, and a running frequency at a preset running position; and obtaining a driving behavior habit safety level as the driving behavior analysis result according to the overspeed frequency, the acceleration frequency, the sharp turning frequency, the running frequency at the preset running position, the running distance and the running time within the preset time.

The overspeed frequency, the acceleration frequency, the sharp turning frequency, the running frequency at the preset running position, the running distance and the running time within the preset time may also be used as the driving behavior analysis result.

In addition, besides counting the driving behavior data cumulatively received within the preset time, the application server can also recognize video images of video data received within the preset time to obtain a lane line distance and a front vehicle distance from the vehicle, so as to count a lane departure frequency that the distance between the vehicle and the lane line is smaller than a departure threshold and a collision early warning frequency that the front vehicle distance is smaller than a collision threshold.

Then, obtaining a driving behavior habit safety level as the driving behavior analysis result according to the overspeed frequency, the acceleration frequency, the sharp turning frequency, the running frequency at the preset running position, the running distance and the running time within the preset time may specifically be:

obtaining a driving behavior habit safety level as the driving behavior analysis result according to the overspeed frequency, the acceleration frequency, the sharp turning frequency, the running frequency at the preset running position, the running distance, the running time, the lane departure frequency, the collision early warning frequency and the like within the preset time.

As another possible implementation, recognizing video images of video data received within the preset time to obtain a distance between the vehicle and the lane line and a front vehicle distance can be executed by the traveling data recorder, the distance between the vehicle and the lane line and the front vehicle distance are used as driving behavior data, and the driving behavior data is counted by the application server.

As a further possible implementation, recognizing video images of video data received within the preset time to obtain a distance between the vehicle and the lane line and a front vehicle distance can also be executed by the electronic equipment, the driving behavior data is transmitted from the electronic equipment to the application server, and the application server performs statistical analysis on the driving behavior data acquired by the traveling data recorder as well as the distance between the vehicle and the lane line and the front vehicle distance recognized from the video data to obtain a driving behavior habit safety level.

Different driving behavior habit safety levels express degrees of driving behavior safety; the higher the safety level is, the safer the driving behavior is; and the lower the safety level is, the unsafer the driving behavior is.

The driving behavior habit safety level may be expressed by a safety coefficient. The corresponding relation between different driving behavior habit safety levels and safety degrees can be preset.

The relation between the overspeed frequency, the acceleration frequency, the sharp turning frequency, the running frequency at the preset running position, the running distance, the running time, the lane departure frequency, the collision early warning frequency and the like within the preset time and the driving behavior habit safety level can be preset and expressed through an expression. For example:

it is supposed that the driving behavior habit includes five types of data expressed by a, b, c, d and e, the weight of each type of data is different, and the weight expresses the influence degree of this type of data on the safety coefficient;
the driving behavior habit safety level can be expressed by the following expression: ax+by+cz+dw+eu=M, wherein x, y, z, w and u respectively express a weight coefficient, the specific values of a, b, c, d and e in the driving behavior habit are substituted into the expression, and the driving behavior habit safety level can be obtained.

As a further embodiment, after obtaining a driving behavior habit safety level as the driving behavior analysis result according to the overspeed frequency, the acceleration frequency, the sharp turning frequency, the running frequency at the preset running position, the running distance and the running time within the preset time, the method may further include:

comparing the driving behavior habit safety level with the driving behavior habit safety level obtained from the driving behavior data transmitted by any electronic equipment associated with the electronic equipment, to obtain a safety level rank and/or vehicles superior to the driving behavior habit safety level and the number of the vehicles as the driving behavior analysis result.

Because the application server can be connected with multiple pieces of electronic equipment, the driving behavior data of the traveling data recorder connected with the electronic equipment within the preset time, transmitted by each piece of electronic equipment, can be counted according to the above manner to obtain the driving behavior habit safety level.

Thus, the driving behavior habit safety level corresponding to the electronic equipment can be compared with the driving behavior habit safety level of any electronic equipment associated with the electronic equipment, and the comparison result can also be used as a driving behavior analysis result and transmitted to the electronic equipment, so that a user not only can learn own driving behavior habit, but also can acquire the comparison with the driving behavior habit of a friend.

The comparison result may include a safety level rank and/or vehicles superior to the driving behavior habit safety level corresponding to the electronic equipment and the number of the vehicles, etc.

Then the electronic equipment outputs the driving behavior analysis result, so that the user can learn the driving safety level rank with friends and acquire the number of vehicles higher than own driving safety level.

As a further embodiment, the application server can further send road condition information corresponding to the running position in the driving behavior data to the electronic equipment, and the electronic equipment outputs the road condition information.

The road condition information may include degree of traffic jam, number of traffic lights, number of electronic eyes, etc.

The road condition information may be acquired by recognizing the video images of the video data in the acquired data through the application server.

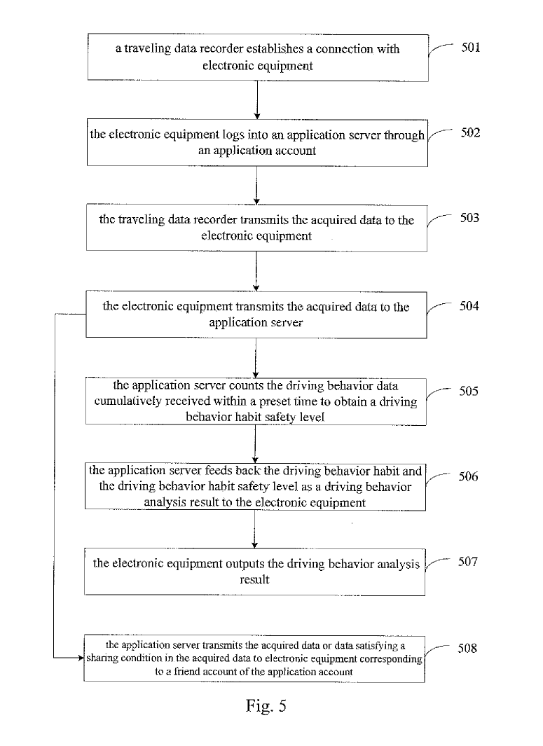

FIG. 5 is a flow diagram of a further embodiment of the data processing method provided by the present disclosure. The method may include the following several steps.

501: a traveling data recorder establishes a connection with electronic equipment.

502: the electronic equipment logs into an application server through an application account.

503: the traveling data recorder transmits the acquired data to the electronic equipment.

The acquired data at least includes video data and/or driving behavior data.

The driving behavior data at least includes running distance, running time, running speed, running acceleration, running angular speed and/or running position.

504: the electronic equipment transmits the acquired data to the application server.

505: the application server counts the driving behavior data cumulatively received within a preset time to obtain a driving behavior habit safety level.

506: the application server feeds back the driving behavior habit and the driving behavior habit safety level as a driving behavior analysis result to the electronic equipment.

After the driving behavior habit safety level is obtained, the driving behavior habit safety level may be further compared with the driving behavior habit safety level obtained according to the driving behavior data transmitted by any electronic equipment associated with the electronic equipment to obtain a comparison result, and the comparison result is fed back to the electronic equipment as the driving behavior analysis result likewise.

The comparison result may include a safety level rank and/or vehicles superior to the driving behavior habit safety level and the number of the vehicles.

507: the electronic equipment outputs the driving behavior analysis result.

508: the application server transmits the acquired data or data satisfying a sharing condition in the acquired data to electronic equipment corresponding to a friend account of the application account.

According to the embodiment of the present disclosure, data sharing is realized through the traveling data recorder, the electronic equipment and the application server, to increase the driving interactivity and improve the driving fun; a large amount of cumulatively received driving behavior data can be further counted to obtain a driving behavior analysis result, and the driving behavior analysis result is sent to the electronic equipment and output by the electronic equipment, so that a user can learn own driving behavior habit in real time to improve the driving safety. The traveling data recorder is sufficiently utilized for recording images and video during running of the vehicle, so that the function of the traveling data recorder is enriched.

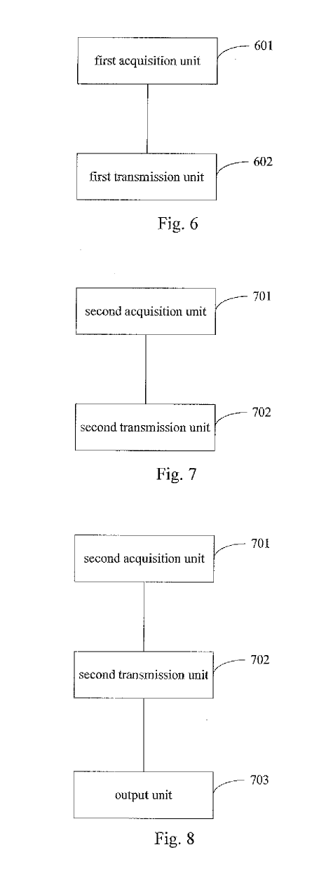

FIG. 6 is a structural schematic diagram of an embodiment of a data processing device provided by the embodiments of the present disclosure. The device is specifically applied to a traveling data recorder, and may be integrated in a processor or a microcontroller in the traveling data recorder. The traveling data recorder may further include an image acquisition module, a motion parameter detection module, a positioning module and the like which are connected with the device.

The image acquisition module may be a camera and the like, for example, and is used for acquiring images and video and the like in the vehicle running process. The traveling data recorder is generally installed on a front windshield or around a rear reflector of a vehicle, to obtain a relatively wide view acquisition range of the traveling data recorder, so as to acquire running video data.

The motion parameter detection module may include sensors capable of detecting motion parameters, such as a speed sensor, an acceleration sensor, an angular speed sensor or a gyro, etc., so as to acquire data of running speed, running acceleration, running angular speed, running direction and the like of a vehicle.

The positioning module may be a device for positioning, such as a GPS (Global Positioning System), so as to acquire data of running locus, running distance, running position and the like.

The device may further include:

a first acquisition unit 601 for acquiring the acquired data of the traveling data recorder, wherein the acquired data at least includes video data and/or driving behavior data, and the driving behavior data at least includes running distance, running speed, running acceleration, running angular speed and/or running position; and
a first transmission unit 602 for transmitting the acquired data to electronic equipment connected with the traveling data recorder, triggering the electronic equipment to transmit the acquired data to an application server, and sending, by the application server, the acquired data or data satisfying a sharing condition in the acquired data to any electronic equipment associated with the electronic equipment.

The sharing condition may indicate a preset type of data, such as running locus, running speed, running position, video images and the like.

The sharing condition may further indicate data requested for sharing by a user, that is, the electronic equipment can receive a user request, and the data requested for sharing by a user in the driving behavior data can be shared according to the user request.

The electronic equipment specifically logs into the application server through an application account, to establish a connection with the application server, and any electronic equipment associated with the electronic equipment is the one corresponding to a friend account of the application account.

In the embodiment of the present disclosure, the traveling data recorder can be connected with the electronic equipment and transmit the acquired data thereof to the electronic equipment, the electronic equipment can transmit the acquired data to the application server, and the application server can send the acquired data or the data satisfying the sharing condition in the acquired data to any electronic equipment associated with the electronic equipment, so that the driving interactivity is increased and the driving fun is improved. According to the technical solution of the embodiment of the present disclosure, the traveling data recorder not only can be used for recording images during running of a vehicle, but also can interact data with the electronic equipment, thus realizing data sharing with other electronic equipment, improving the driving fun and enriching the function of the traveling data recorder.

As a further embodiment, the acquired data of the traveling data recorder may further include a current vehicle running image. Thus, the first acquisition unit 601 acquiring the acquired data of the traveling data recorder includes acquiring and obtaining a current vehicle running image when receiving an image acquisition instruction.

Hence, the electronic equipment may further transmit the current vehicle running image to the application server, and the application server sends the current vehicle running image to any electronic equipment associated with the electronic equipment.

During running of the vehicle, the image recorded by the traveling data recorder is video data. If a user desires to record key environment content of a scene along the way or at an important position during running of the vehicle, a video recording manner is adopted, and it is relatively cumbersome to search the key environment content from the video data later.

Thus, in the embodiment of the present disclosure, the image acquisition module in the traveling data recorder can also be utilized for shooting to acquire the current vehicle running image.

The image acquisition instruction may be sent from the electronic equipment to the traveling data recorder or from control equipment to the traveling data recorder.

The electronic equipment or the control equipment may send the image acquisition instruction to the traveling data recorder when receiving a trigger operation of a user.

In order to facilitate user operation, the control equipment may be arranged in a steering wheel of the vehicle, so that when the user discovers a beautiful scene or other environment content desired to be shot, the user can operate the control equipment on the steering wheel in time, and the control equipment can generate an image acquisition instruction and send the image acquisition instruction to the traveling data recorder, to trigger the traveling data recorder to perform image acquisition and shoot a current running image.

Thus, as a further embodiment, the first acquisition unit 601 acquiring a current vehicle running image when receiving an image acquisition instruction includes: acquiring and obtaining a current vehicle image when receiving an image acquisition instruction generated when the control equipment arranged in the steering wheel responds to a user trigger operation.

FIG. 7 is a structural schematic diagram of another embodiment of the data processing device provided by the embodiments of the present disclosure. The device is specifically applied to electronic equipment, can be integrated to a processor of the electronic equipment, and can also be connected with the processor of the electronic equipment as an independent module.

The electronic equipment may be portable mobile equipment such as a mobile phone, a tablet personal computer and the like. The portable mobile equipment is generally carried by a user, and when the user drives a vehicle, the carried electronic equipment can be connected with the traveling data recorder in the vehicle.

The connection between the electronic equipment and the traveling data recorder may be short-distance wireless communication connection, such as Bluetooth connection and the like. In order to improve the transmission rate, the connection between the electronic equipment and the traveling data recorder may be wifi connection, and the traveling data recorder may be used as a wifi hotspot.

The device may include:

a second acquisition unit 701 for receiving acquired data transmitted by a traveling data recorder, wherein the acquired data is acquired and obtained by the traveling data recorder and at least includes video data and/or driving behavior data, and the driving behavior data at least includes running distance, running speed, running acceleration, running angular speed and/or running position; and
a second transmission unit 702 for transmitting the acquired data to an application server, and sending, by the application server, the acquired data or data satisfying a sharing condition in the acquired data to any electronic equipment associated with the electronic equipment.

In this embodiment, the electronic equipment can be connected with the traveling data recorder in the vehicle so as to receive or request for acquiring the acquired data of the traveling data recorder and can transmit the acquired data to the application server, and the application server sends the acquired data to any electronic equipment associated with the electronic equipment. Any electronic equipment associated with the electronic equipment may be the one corresponding to a friend of the electronic equipment user. Thus, during running of the vehicle, data sharing with a friend is realized, the driving interactivity is increased, the driving fun is improved, the traveling data recorder is sufficiently utilized, and the function of the traveling data recorder is enriched.

As a further embodiment, the application server can further count the driving behavior data in the acquired data to obtain a driving behavior analysis result after receiving the acquired data, wherein the driving behavior analysis result is used for expressing whether the driving behavior habit of the vehicle is safe.

The application server can further feed back the obtained driving behavior analysis result to the electronic equipment for output by the electronic equipment, to prompt the user whether the current driving behavior habit is safe, so that the user can correct the driving behavior habit to keep a safe driving behavior.

Thus, as shown in FIG. 8, the device may further include:

an output unit 703 for receiving and outputting a driving behavior analysis result fed back by the application server, wherein the driving behavior analysis result is obtained by counting the driving behavior data cumulatively received within a preset time through the application server, and is used for expressing whether the driving behavior habit of the vehicle is safe.

The driving behavior analysis result is obtained by processing the driving behavior data cumulatively received within the preset time, namely a large amount of driving behavior data, thus ensuring the accuracy of the analysis result. The preset time may be ten days, one month, six months or one year, etc.

The driving behavior data may be processed to obtain a driving behavior assessment result in multiple manners, which will be introduced in detail in the following embodiments.

The acquired data of the traveling data recorder, received by the electronic equipment, includes a current vehicle running image acquired and obtained when the traveling data recorder receives an image acquisition instruction.

That is, the image acquisition module shoots an image when receiving the image acquisition instruction.

The image acquisition instruction received by the traveling data recorder may specifically be generated when the control equipment connected with the traveling data recorder responds to a user trigger operation.

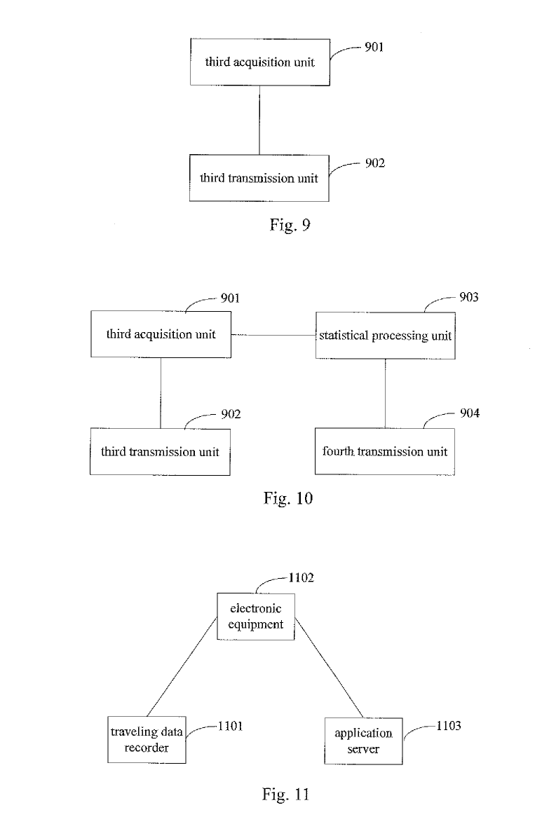

FIG. 9 is a structural schematic diagram of a further embodiment of the data processing device provided by the present disclosure. The device is specifically applied to an application server.

Electronic equipment can log in the application server through an application account to connect the application server. The application server may be connected with different electronic equipment, and the different electronic equipment logs into the application server through respective application account to communicate with the application server.

The device may include:

a third acquisition unit 901 for receiving acquired data transmitted by electronic equipment, wherein the acquired data is acquired by and transmitted to the electronic equipment by the traveling data recorder and at least includes video data and/or driving behavior data, and the driving behavior data at least includes running distance, running speed, running acceleration, running angular speed and/or running position; and
a third transmission unit 902 for transmitting the acquired data or data satisfying a sharing condition in the acquired data to any electronic equipment associated with the electronic equipment.

According to a further embodiment, as shown in FIG. 10, the device may further include:

a statistical processing unit 903 for counting the driving behavior data cumulatively received within a preset time to obtain a driving behavior analysis result, wherein the driving behavior analysis result is used for expressing whether the driving behavior habit of the vehicle is safe; and
a fourth transmission unit 904 for sending the driving behavior analysis result to the electronic equipment for output by the electronic equipment.

In the embodiment of the present disclosure, the traveling data recorder can be connected with the electronic equipment and transmit the acquired driving behavior data to the electronic equipment, the electronic equipment can transmit the driving behavior data to the application server, and the application server not only transmits the acquired data or the data satisfying the sharing condition in the acquired data to any electronic equipment associated with the electronic equipment to increase the driving interactivity and improve the driving fun, but also can count a large amount of cumulatively received driving behavior data to obtain a driving behavior analysis result for expressing whether the driving behavior habit is safe, and sends the driving behavior analysis result to the electronic equipment, and the electronic equipment outputs the driving behavior analysis result, so that a user can learn own driving behavior habit in time to improve the driving safety. In the embodiment of the present disclosure, the traveling data recorder is sufficiently utilized for recording images and video during running of the vehicle, so that the function of the traveling data recorder is enriched.

The driving behavior analysis result may include driving behavior habit, driving behavior habit safety level, result of comparison with other user driving behavior habit, etc.

Thus, as a further embodiment, the statistical processing unit may include: a statistical sub-unit for counting the driving behavior data cumulatively received within the preset time, to at least obtain an overspeed frequency that the running speed is greater than a speed threshold, a sharp acceleration frequency that the running acceleration is greater than an acceleration threshold, a sharp turning frequency that the running angular speed is greater than an angular speed threshold, and a running frequency at a preset running position; and

a processing sub-unit for obtaining a driving behavior habit safety level as the driving behavior analysis result according to the overspeed frequency, the acceleration frequency, the sharp turning frequency, the running frequency at the preset running position, the running distance and the running time within the preset time.

Different driving behavior habit safety levels express degrees of driving behavior safety; the higher the safety level is, the safer the driving behavior is; and the lower the safety level is, the unsafer the driving behavior is.

The driving behavior habit safety level may be expressed by a safety coefficient. The corresponding relation between different driving behavior habit safety levels and safety degrees can be preset.

As a further embodiment, the statistical processing unit may further include: a comparison sub-unit for comparing the driving behavior habit safety level with the driving behavior habit safety level obtained from the driving behavior data transmitted by any electronic equipment associated with the electronic equipment, to obtain a comparison result as the driving behavior analysis result.

Because the application server can be connected with multiple pieces of electronic equipment, the driving behavior data of the traveling data recorder connected with the electronic equipment within the preset time, transmitted by each piece of electronic equipment, can be counted according to the above manner to obtain the driving behavior habit safety level.

Thus, the driving behavior habit safety level corresponding to the electronic equipment can be compared with the driving behavior habit safety level of any electronic equipment associated with the electronic equipment, and the comparison result can also be used as a driving behavior analysis result and transmitted to the electronic equipment, so that a user not only can learn own driving behavior habit, but also can acquire the comparison with the driving behavior habit of a friend.

The comparison result may include a safety level rank and/or vehicles superior to the driving behavior habit safety level corresponding to the electronic equipment and the number of the vehicles, etc.

Then the electronic equipment outputs the driving behavior analysis result, so that the user can learn the driving safety level rank with friends and acquire the number of vehicles higher than own driving safety level.

As a further embodiment, the device may further include:

a fifth transmission unit for sending road condition information corresponding to the running position in the driving behavior data to the electronic equipment for output by the electronic equipment.

The road condition information may include degree of traffic jam, number of traffic lights, number of electronic eyes, etc.

The road condition information may be acquired by recognizing the video images of the video data in the acquired data through the application server.

In addition, the present disclosure further provides a data processing system. As mentioned in FIG. 11, the data processing system may include a traveling data recorder 1101, electronic equipment 1102 and an application server 1103.

The traveling data recorder 1101 includes the data processing device described by the corresponding embodiment of FIG. 6; the electronic equipment 1102 includes the data processing device described by the corresponding embodiment of FIG. 7 or FIG. 8; and the application server 1103 includes the data processing device described by the corresponding embodiment of FIG. 9 or FIG. 10.

The traveling data recorder 1101 is used for acquiring data and transmitting the acquired data to the electronic equipment;

the electronic equipment 1102 is used for receiving the acquired data transmitted by the traveling data recorder and transmitting the acquired data to the application server; and
the application server 1103 is used for transmitting the acquired data or data satisfying a sharing condition in the acquired data to any electronic equipment associated with the electronic equipment.

Moreover, the application server 1103 may be further used for counting the driving behavior data cumulatively received within a preset time to obtain a driving behavior analysis result, wherein the driving behavior analysis result is used for expressing whether the driving behavior habit of the vehicle is safe; and

sending the driving behavior analysis result to the electronic equipment for output by the electronic equipment.

The application server counting the driving behavior data cumulatively received within a preset time to obtain a driving behavior analysis result may specifically be:

counting the driving behavior data cumulatively received within the preset time, to at least obtain an overspeed frequency that the running speed is greater than a speed threshold, a sharp acceleration frequency that the running acceleration is greater than an acceleration threshold, a sharp turning frequency that the running angular speed is greater than an angular speed threshold, and a running frequency at a preset running position;
obtaining a driving behavior habit safety level as the driving behavior analysis result according to the overspeed frequency, the acceleration frequency, the sharp turning frequency, the running frequency at the preset running position, the running distance and the running time within the preset time; and
comparing the driving behavior habit safety level with the driving behavior habit safety level obtained from the driving behavior data transmitted by any electronic equipment associated with the electronic equipment, to obtain a safety level rank and/or vehicles superior to the driving behavior habit safety level and the number of the vehicles as the driving behavior analysis result.

Through the data processing system provided by the embodiment of the present disclosure, the acquired data of the traveling data recorder can be shared in the vehicle driving process, thus increasing the driving interactivity and improving the driving fun; and the driving behavior habit and the driving behavior habit safety level can be obtained according to the acquired data of the traveling data recorder, output to the electronic equipment and viewed by a user to remind the user of correcting the unsafe driving behavior, thus improving the driving safety. The traveling data recorder is sufficiently utilized for singly acquiring video data, so that the function of the traveling data recorder is enriched.

The device embodiments described above are merely schematic, wherein the units illustrated as separate components may be or may not be physically separated, and the components displayed as units may be or may not be physical units, that is to say, the components may be positioned at one place or may also be distributed on a plurality of network units. The objectives of the solutions of the embodiments may be fulfilled by selecting part of or all of the modules according to actual needs. Those of ordinary skill in the art could understand and implement the embodiments without any creative effort.

Through the descriptions of the above embodiments, those skilled in the art could clearly learn that each embodiment may be realized by means of software and a necessary general hardware platform, and of course, may be realized by hardware. Based on such a understanding, the above technical solutions substantially or the part making contribution to the prior art may be embodied in the form of a software product, and the computer software product is stored in a computer readable storage medium, such as an ROM (Read-Only Memory)/RAM (Random Access Memory), a disk, an optical disk and the like, which includes a plurality of instructions enabling computer equipment (which may be a personal computer, a server, or network equipment and the like) to execute each embodiment or the method at some part of each embodiment.

Finally, it should be noted that the above embodiments are merely used for illustrating rather than limiting the technical solutions of the present disclosure; although the present disclosure is illustrated in detail with reference to the aforementioned embodiments, it should be understood by those of ordinary skill in the art that modifications may still be made on the technical solutions disclosed in the aforementioned respective embodiments, or equivalent substitutions may be made to part of technical characteristics thereof; and these modifications or substitutions shall not make the nature of the corresponding technical solutions depart from the spirit and scope of the technical solutions of the respective embodiments of the present disclosure.

What is claimed is:

1. A data processing method, applied to a traveling data recorder, the method comprising:
acquiring the acquired data of the traveling data recorder, wherein the acquired data at least comprises video data and/or driving behavior data, and the driving behavior data at least comprises running distance, running speed, running acceleration, running angular speed and/or running position; and
transmitting the acquired data to electronic equipment connected with the traveling data recorder, triggering the electronic equipment to transmit the acquired data to an application server, and sending, by the application server, the acquired data or data satisfying a sharing condition in the acquired data to any electronic equipment associated with the electronic equipment.

2. The method of claim 1, wherein the acquired data comprises a current vehicle running image, and acquiring the acquired data of the traveling data recorder comprises:
acquiring and obtaining a current vehicle running image when receiving an image acquisition instruction.

3. The method of claim 2, wherein acquiring a current vehicle running image when receiving an image acquisition instruction comprises:
acquiring and obtaining a current vehicle image when receiving an image acquisition instruction generated when control equipment arranged in a steering wheel responds to a user trigger operation.

4. A data processing method, applied to electronic equipment, the method comprising:
receiving acquired data transmitted by a traveling data recorder, wherein the acquired data is acquired and obtained by the traveling data recorder and at least comprises video data and/or driving behavior data, and the driving behavior data at least comprises running distance, running speed, running acceleration, running angular speed and/or running position; and
transmitting the acquired data to an application server, and sending, by the application server, the acquired data or data satisfying a sharing condition in the acquired data to any electronic equipment associated with the electronic equipment.

5. The method of claim 4, wherein after transmitting the acquired data to the application server, the method further comprises:
receiving and outputting a driving behavior analysis result fed back by the application server, wherein the driving behavior analysis result is obtained by counting the driving behavior data cumulatively received within a preset time through the application server, and is used for expressing whether the driving behavior habit of the vehicle is safe.

6. A data processing method, applied to an application server, the method comprising:
receiving acquired data transmitted by electronic equipment, wherein the acquired data is acquired by and transmitted to the electronic equipment by the traveling data recorder and at least comprises video data and/or driving behavior data, and the driving behavior data at least comprises running distance, running speed, running acceleration, running angular speed and/or running position; and
transmitting the acquired data or data satisfying a sharing condition in the acquired data to any electronic equipment associated with the electronic equipment.

7. The method of claim 6, wherein after receiving the acquired data transmitted by the electronic equipment, the method further comprises:
counting the driving behavior data cumulatively received within a preset time to obtain a driving behavior analysis result, wherein the driving behavior analysis result is used for expressing whether the driving behavior habit of the vehicle is safe; and
sending the driving behavior analysis result to the electronic equipment for output by the electronic equipment.

8. The method of claim 7, wherein counting the driving behavior data cumulatively received within a preset time to obtain a driving behavior analysis result comprises:
counting the driving behavior data cumulatively received within the preset time, to at least obtain an overspeed frequency that the running speed is greater than a speed threshold, a sharp acceleration frequency that the running acceleration is greater than an acceleration threshold, a sharp turning frequency that the running angular speed is greater than an angular speed threshold, and a running frequency at a preset running position; and
obtaining a driving behavior habit safety level as the driving behavior analysis result according to the overspeed frequency, the acceleration frequency, the sharp turning frequency, the running frequency at the preset running position, the running distance and the running time within the preset time.

9. The method of claim 8, wherein after obtaining the driving behavior habit safety level as the driving behavior analysis result according to the overspeed frequency, the acceleration frequency, the sharp turning frequency, the running frequency at the preset running position, the running distance and the running time within the preset time, the method further comprises:
comparing the driving behavior habit safety level with the driving behavior habit safety level obtained from the driving behavior data transmitted by any electronic equipment associated with the electronic equipment, to obtain a comparison result as the driving behavior analysis result.

10. The method of claim 6, wherein after transmitting the acquired data or the data satisfying the sharing condition in the acquired data to any electronic equipment associated with the electronic equipment, the method further comprises:
sending road condition information corresponding to the running position in the driving behavior data to the electronic equipment, and outputting the road condition information by the electronic equipment.

11. A data processing system, comprising a traveling data recorder, electronic equipment and an application server, wherein
the traveling data recorder is used for acquiring data and transmitting the acquired data to the electronic equipment, and comprises a data processing device, comprising:
one or more processors; and a storage;
one or more programs, stored in the storage and performing the following steps when being executed by the one or more processors:
acquiring the acquired data of the traveling data recorder, wherein the acquired data at least comprises video data and/or driving behavior data, and the driving behavior data at least comprises running distance, running speed, running acceleration, running angular speed and/or running position; and
transmitting the acquired data to electronic equipment connected with the traveling data recorder, triggering the electronic equipment to transmit the acquired data to an application server, and sending, by the application server, the acquired data or data satisfying a sharing condition in the acquired data to any electronic equipment associated with the electronic equipment;
the electronic equipment is used for receiving the acquired data transmitted by the traveling data recorder and transmitting the acquired data to the application server, and comprises a data processing device, comprising
one or more processors; and
a storage;
one or more programs, stored in the storage and performing the following steps when being executed by the one or more processors:
receiving acquired data transmitted by a traveling data recorder, wherein the acquired data is acquired and obtained by the traveling data recorder and at least comprises video data and/or driving behavior data, and the driving behavior data at least comprises running distance, running speed, running acceleration, running angular speed and/or running position; and
transmitting the acquired data to an application server, and sending, by the application server, the acquired data or data satisfying a sharing condition in the acquired data to any electronic equipment associated with the electronic equipment; and
the application server is used for transmitting the acquired data or data satisfying a sharing condition in the acquired data to any electronic equipment associated with the electronic equipment, and comprises a data processing device, comprising:
one or more processors; and
a storage;
one or more programs, stored in the storage and performing the following steps when being executed by the one or more processors:
receiving acquired data transmitted by electronic equipment, wherein the acquired data is acquired by and transmitted to the electronic equipment by the traveling data recorder and at least comprises video data and/or driving behavior data, and the driving behavior data at least comprises running distance, running time, running speed, running acceleration, running angular speed and/or running position; and
transmitting the acquired data or data satisfying a sharing condition in the acquired data to any electronic equipment associated with the electronic equipment.

12. The data processing system of claim 11, wherein the acquired data comprises a current vehicle running image, and acquiring the acquired data of the traveling data recorder comprises:
acquiring and obtaining a current vehicle running image when receiving an image acquisition instruction.

13. The data processing system of claim 12, wherein acquiring a current vehicle running image when receiving an image acquisition instruction comprises:
acquiring and obtaining a current vehicle image when receiving an image acquisition instruction generated when control equipment arranged in a steering wheel responds to a user trigger operation.

14. The data processing system of claim 11, wherein after transmitting the acquired data to the application server, the method further comprises:
receiving and outputting a driving behavior analysis result fed back by the application server, wherein the driving behavior analysis result is obtained by counting the driving behavior data cumulatively received within a preset time through the application server, and is used for expressing whether the driving behavior habit of the vehicle is safe.

15. The data processing system of claim 11, wherein after receiving the acquired data transmitted by the electronic equipment, the method further comprises:
counting the driving behavior data cumulatively received within a preset time to obtain a driving behavior analysis result, wherein the driving behavior analysis result is used for expressing whether the driving behavior habit of the vehicle is safe; and
sending the driving behavior analysis result to the electronic equipment for output by the electronic equipment.

16. The data processing system of claim 15, wherein counting the driving behavior data cumulatively received within a preset time to obtain a driving behavior analysis result comprises:
counting the driving behavior data cumulatively received within the preset time, to at least obtain an overspeed frequency that the running speed is greater than a speed threshold, a sharp acceleration frequency that the ruining acceleration is greater than an acceleration threshold, a sharp turning frequency that the running angular speed is greater than an angular speed threshold, and a running frequency at a preset running position; and
obtaining a driving behavior habit safety level as the driving behavior analysis result according to the overspeed frequency, the acceleration frequency, the sharp turning frequency, the running frequency at the preset running position, the running distance and the running time within the preset time.

17. The data processing system of claim 16, wherein after obtaining the driving behavior habit safety level as the driving behavior analysis result according to the overspeed frequency, the acceleration frequency, the sharp turning frequency, the running frequency at the preset running position, the running distance and the running time within the preset time, the method further comprises:
comparing the driving behavior habit safety level with the driving behavior habit safety level obtained from the driving behavior data transmitted by any electronic equipment associated with the electronic equipment, to obtain a comparison result as the driving behavior analysis result.

18. The data processing system of claim 11, wherein after transmitting the acquired data or the data satisfying the sharing condition in the acquired data to any electronic equipment associated with the electronic equipment, the method further comprises:
sending road condition information corresponding to the running position in the driving behavior data to the electronic equipment, and outputting the road condition information by the electronic equipment.
